(19) United States
(12) Patent Application Publication
(10) Pub. No.: US 2012/0300460 A1
(43) Pub. Date: Nov. 29, 2012

(54) CONNECTOR AND LED LAMP HAVING THE SAME

(75) Inventors: TAY-JIAN LIU, Tu-Cheng (TW); HONG-BING WANG, Shenzhen City (CN)

(73) Assignees: FOXCONN TECHNOLOGY CO., LTD., Tu-Cheng (TW); FU ZHUN PRECISION INDUSTRY (SHEN ZHEN) CO., LTD., Shenzhen City (CN)

(21) Appl. No.: 13/269,631

(22) Filed: Oct. 10, 2011

(30) Foreign Application Priority Data
May 26, 2011 (CN) 201110138708.X

(51) Int. Cl. F21V 21/00; H01R 24/00; F21V 29/00

(52) U.S. Cl. 362/249.02; 439/626

(57) ABSTRACT

An exemplary LED lamp includes a lamp base, an illumination unit and two connectors. The lamp base includes a main body and an extending portion extending from the main body. An opening is defined in the main body. The illumination unit with LED elements is received in the opening of the main body. The connectors respectively engage with opposite ends of the illumination unit and the main body to fix the illumination unit on the lamp base. Each connector includes a socket and an adjuster. The socket electrically connects the illumination unit. The adjuster includes a stator embed in the main body, and a rotator engaging with the stator and rotatable relative to the stator. The rotator surrounds an end of the socket and rotates with the socket to change an illumination angle of the illumination unit.

### BACKGROUND

1. Technical Field

The present disclosure relates to LED lamps, and particularly to an LED lamp having connectors for adjusting illumination angles of the LED lamp.

2. Description of Related Art

LEDs have many advantages, such as high luminosity, low operational voltage, low power consumption, easy driving, long-term reliability, environmental friendliness for not having to use mercury (Hg), and high impact resistance, which have led LEDs to be widely used as light sources.

Radiant efficiency and lifespan of the LEDs may be distinctly reduced by high working temperatures if an LED illumination device does not include a highly efficient heat dissipating assembly.

Large LED illumination device, such as streetlight, spotlight, and searchlight, includes a base, a heat dissipating assembly having a number of fins and placed on the base, an LED light source mounted on the base opposite to the heat dissipating assembly, a housing received the LED light source therein, and a driving power source placed in the housing to drive the LED light source to illuminate. However, the heavy weight and huge volume of the heat dissipating assembly cause construction, disassembly, and repair for the lamp, especially for the streetlight on a lamp pole to be costly.

In addition, the illumination angle of the LED lamp is fixed and can not be adjusted easily to meet varied requirements of illumination. As such, the usage of the LED lamp is limited.

Accordingly, it is desirable to provide an LED lamp which can overcome the described limitations.

### BRIEF DESCRIPTION OF THE DRAWINGS

FIG. 1 is an assembled, isometric view of an LED lamp according to an embodiment of the present disclosure, in which two mounting plates are removed.

FIG. 2 is an assembled, isometric view of the LED lamp of FIG. 1, but viewed from another aspect, in which two illumination units are removed.

FIG. 3 shows a partially exploded view of an illumination unit of FIG. 1, in which a part of the illumination unit is cutaway for clarity.

FIG. 4 is an enlarged view of a circled part of the illumination unit of FIG. 3.

FIG. 5 is an exploded, isometric view of a connector and a corresponding illumination unit of FIG. 1.

FIG. 6 shows the connector assembled to a connecting plate of the LED lamp.

### DETAILED DESCRIPTION

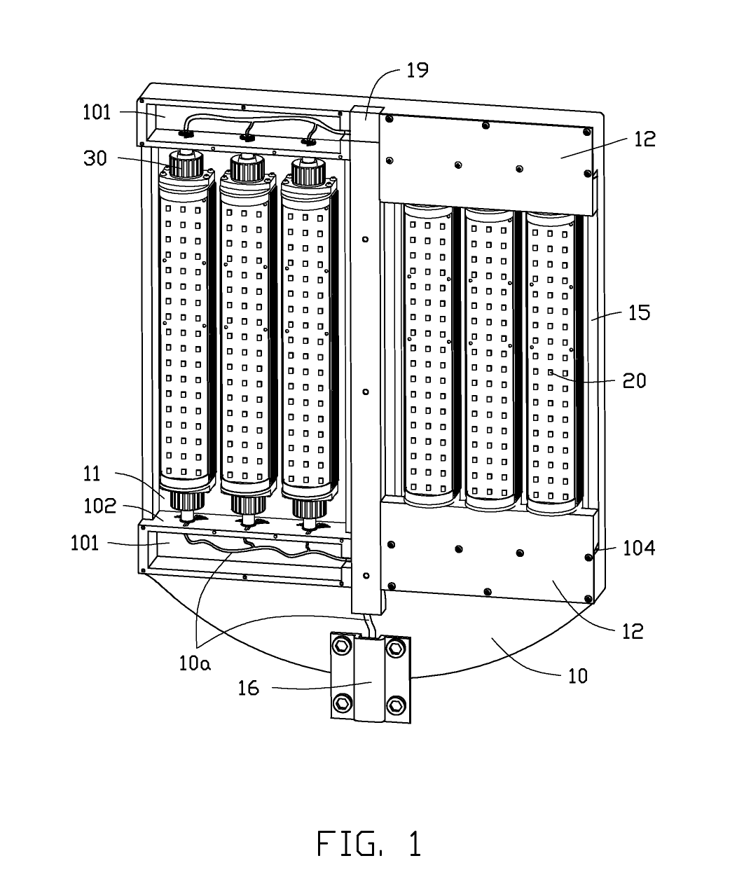

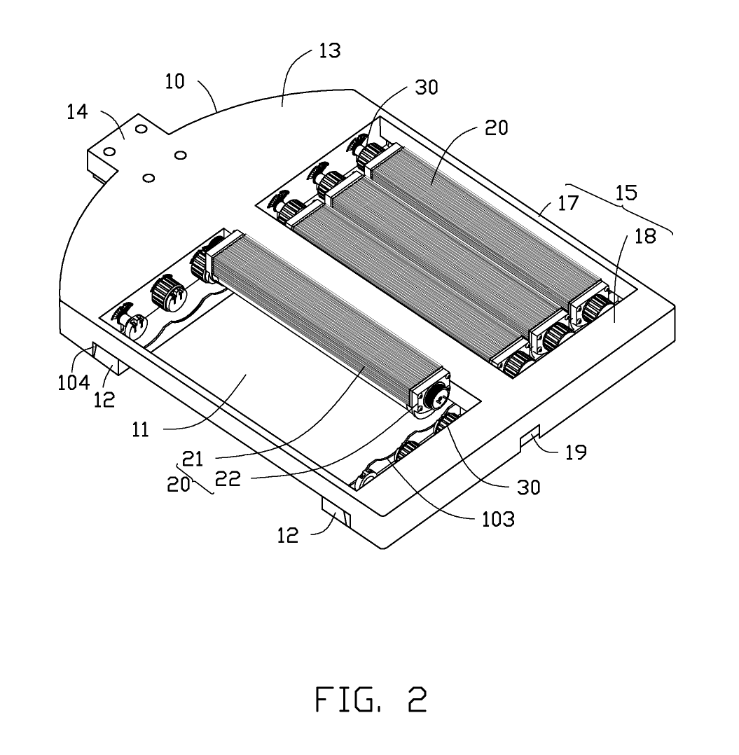

Referring to FIG. 1 and FIG. 2, an LED lamp in accordance with the present disclosure includes a lamp base 10 and two illumination modules mounted on the lamp base 10. A number of power cords 10a electrically connect with the illumination modules, in order to connect the illumination modules with an external power supply (not shown).

The lamp base 10 may be a planar frame, a curved frame, or a combination of several planar frames arranged at an angle to each other. In this embodiment, the lamp base 10 is a planar frame. The lamp base 10 includes a rectangular main body 15, an extending portion 13 extending outwardly from a rear end of the main body 15 and a pole connection unit 14 extending outwardly from a central portion of a rear end of the extending portion 13. An extending plate 16 is fixed to the connecting unit 14 by screws, and can be connected to a lamp pole or other holding device (not shown).

The main body 15 includes three sidewalls 17 and a beam 18. The three sidewalls 17 are parallel to and spaced from each other and extend from a front end of the extending portion 13. The beam 18 is substantially parallel to extending portion 13 to sandwich the three sidewalls 17 therebetween, and each sidewall 17 is perpendicular to the beam 18 and has a front end connected to the beam 18. Three adjacent sidewalls 17, the extending portion 13 and the beam 18 cooperatively define two openings 11 therebetween. The two illumination modules are respectively received in the openings 11. Four wire chutes 101 are located at opposite ends of the main body 15. Two of the wire chutes 101 are defined in a top side of the beam 18 and two of the wire chutes 101 are defined in a top side of an inner end of the extending portion 13. Each of the wire chutes 101 includes a rectangular connecting plate 102. The two connecting plates 102 located at the same lateral side of the middle sidewall 17 sandwich one of the illumination modules therebetween.

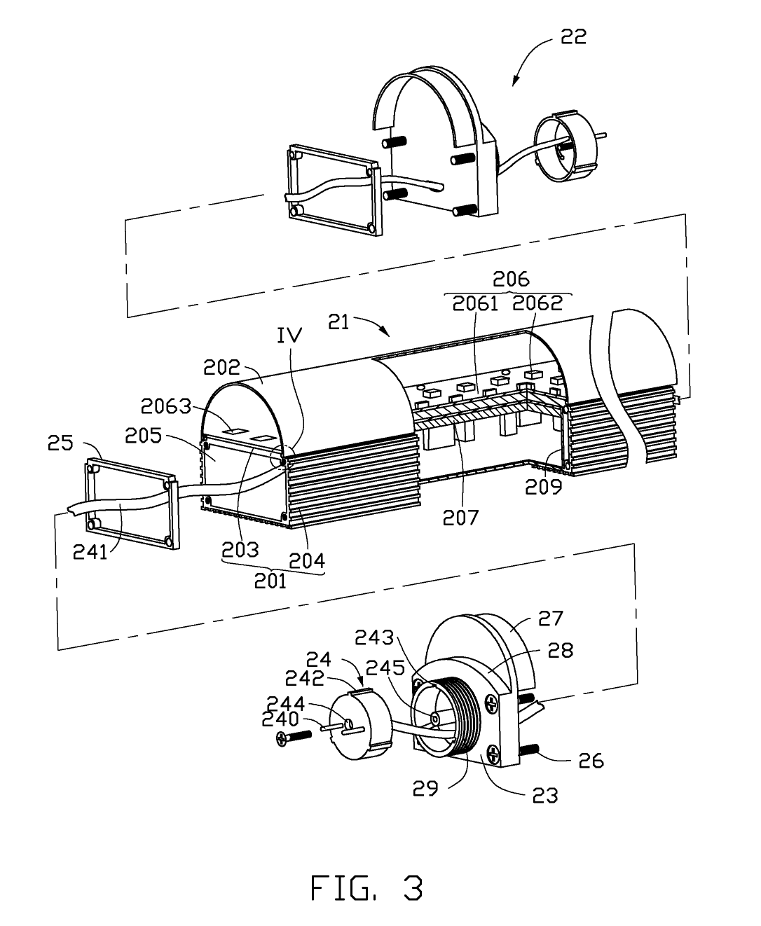

A wire housing 19 is mounted on the middle sidewall 17 and between the two illumination modules to accommodate the power cords 10a. The power cords 10a accommodated in the same wire chute 101 are electrically connected to the same polarity, and the power cords 10a connected to the opposite terminals of the illumination modules are electrically connected to a different polarity, so currents can flow easily from p-type layers to n-type layers of LED chips of LED elements 2062 (FIG. 3). The wire housing 19 can prettify the LED lamp, and weatherproof the power cords 10a.

Each illumination module includes three illumination units 20. Three pairs of connectors 30 are located between the three illumination units 20 and two corresponding connecting plates 102 of the wire chutes 101 at opposite front and rear sides of the illumination module. Each of opposite ends of each of the illumination units 20 engages with a corresponding connector 30. The connectors 30 are adjustable relative to the connecting plates 102 to adjust illumination angles of the illumination unit 20. Two mounting plates 12 respectively cover the two wire chutes 101 of each illumination module, wherein, for clarity, two mounting plates 101 located at the left side are removed for showing the wire chutes 101 and the connectors 30. A plurality of screws penetrate through the mounting plates 12 and threadedly engage with the connecting plates 102 of the wire chutes 101 of the lamp base 10, thereby securing the mounting plates 12 to the lamp base 10.

Each of the mounting plate 12 has a substantially U-shaped configuration. The mounting plates 12 can hermetically seal the wire chutes 101, and cover both the wire chutes 101 and the connectors 30. Three arc-shaped cutouts 103 are defined in a bottom end of the mounting plate 12. Front and rear ends of the illumination units 20 are received in the cutouts 103 and abut the mounting plates 12. Thus, the mounting plates 12 not only prettify the LED lamp, but also support the illumination modules. The LED lamp further defines four drainage pipelines 104 between the mounting plates 12 and the wire chutes 101. The drainage pipelines 104 are located at lateral sides of the LED lamp to drain water (mainly rainwater) from the LED lamp.

The connectors 30 are electrical and mechanical connection units. The illumination units 20 are apart from each other. Accordingly, the illumination units 20 define gaps (not labeled) therebetween to enhance natural convection, and to reduce weight of the LED lamp. The gaps allow wind, snow, rainwater and dust to pass through, so as to prevent possible overload caused by these foreign matter on the LED lamp.

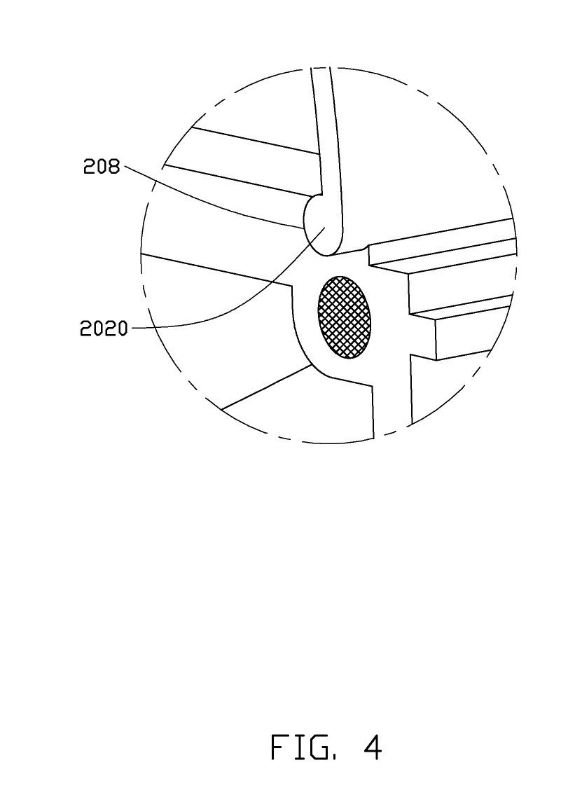

Referring also to FIGS. 3-4, each illumination unit 20 is relatively long and narrow. Each illumination unit 20 includes a long lamp module 21, two connection units 22 connected to two opposite terminals of the lamp module 21, and two power cords 241 extending in the lamp module 21 and the connection units 22. Each lamp module 21 includes a long, hollow, heat dissipating assembly 201, a lighting assembly 206, a printed circuit board 207, and a long light guide housing 202.

The heat dissipating assembly 201 is made of thermally conductive material, such as metal. The heat dissipating assembly 201 includes a heat dissipating base 203 and a U-shaped heat dissipating case 204. The heat dissipating base 203 is substantially a flat plate. The outer surface of the heat dissipating base 203 is an endothermic surface contacting with the lighting assembly 206. The heat dissipating base 203 defines two slots 208 respectively at opposite sides of the endothermic surface thereof. The lighting guiding housing 202 engages in the slots 208. The heat dissipating base 203 and the heat dissipating case 204 cooperatively define a hollow rectangular chamber 205 therein. A plurality of narrow fins (shown in FIG. 3) protrudes from an outer periphery of the heat dissipating case 204 to improve heat dissipation efficiency of the heat dissipating assembly 201. It is noted that the fins are not limited to the shown embodiment, and may include any appropriate shapes, such as pins, columns or wide fins. The heat dissipating assembly 201 provides physical protection and heat-conduction to ensure the reliability of the illumination units 20. The metal wall of the heat dissipating assembly 201 provides electromagnetic shielding to protect surroundings and the circuits and other electronic elements therein.

The lighting assembly 206 is mounted on the endothermic surface of the heat dissipating base 203. The lighting assembly 206 includes an elongated light source base 2061, a number of LED elements 2062 located on the light source base 2061, and a number of electrodes 2063. The electrodes 2063 are formed on the light source base 2061, and are electrically connected to the LED elements 2062. Each LED element 2062 may include at least one LED chip sealed by a transparent material. The light source base 2061 of the lighting assembly 206 contacts the endothermic surface of the heat dissipating base 203. The heat dissipating base 203 may include a thermal interface material (TIM, not labeled) interposed between the light source base 2061 and the endothermic surface. The light source base 2061 may be tightly fixed to the heat dissipating base 203 by screws. The heat produced from the LED elements 2062 can be effectively transferred from the lighting assembly 206 to the heat dissipating case 204. The temperature difference between the illumination units 20 and the surroundings causes natural convection in the gaps between the adjacent illumination units 20, and the large outer surface of the heat dissipating assembly 201 and the gaps make the natural convection more active so that the heat can be easily dissipated.

The printed circuit board 207 is located in the hollow chamber 205 defined by the heat dissipating assembly 201. The power cord 241 is electrically connected to the electrode (not shown) of the printed circuit board 207. The printed circuit board 207 transmits driving current to the lighting assembly 206, and controls the power supplied to the LED elements 2062. Since the hollow heat dissipating assembly 201 is made of metal in this embodiment, the lamp module 21 further includes an electrically insulating sleeve 209 located in the hollow heat dissipating assembly 201 to surround the printed circuit board 207. The sleeve 209 electrically insulates the printed circuit board 207 from the hollow heat dissipating assembly 201. The sleeve 209 can be made of thermally conductive material to enhance heat dissipation.

The light guide housing 202 has a transparent, arc-shaped configuration and encloses the lighting assembly 206 therein. The light guide housing 202 includes two flanges 2020 respectively at two opposite edges thereof and corresponding to the two slots 208 of the heat dissipating base 203. The two flanges 2020 are parallel to the extension direction of the lamp module 21. The two flanges 2020 extend inward and respectively insert into the two slots 208 of the heat dissipating base 203. As such, the light guide housing 202 is fixed to the heat dissipating base 203. The heat dissipating base 203 seals a bottom end of the light guide housing 202. The light guide housing 202 can adjust the illumination distribution of the LED lamp, and protect the lighting assembly 206. In other embodiments, each illumination unit 20 may further include lenses or reflective elements to enhance the optical performances of the LED elements 2062 of the LED lamp, for example, illumination distribution and brightness.

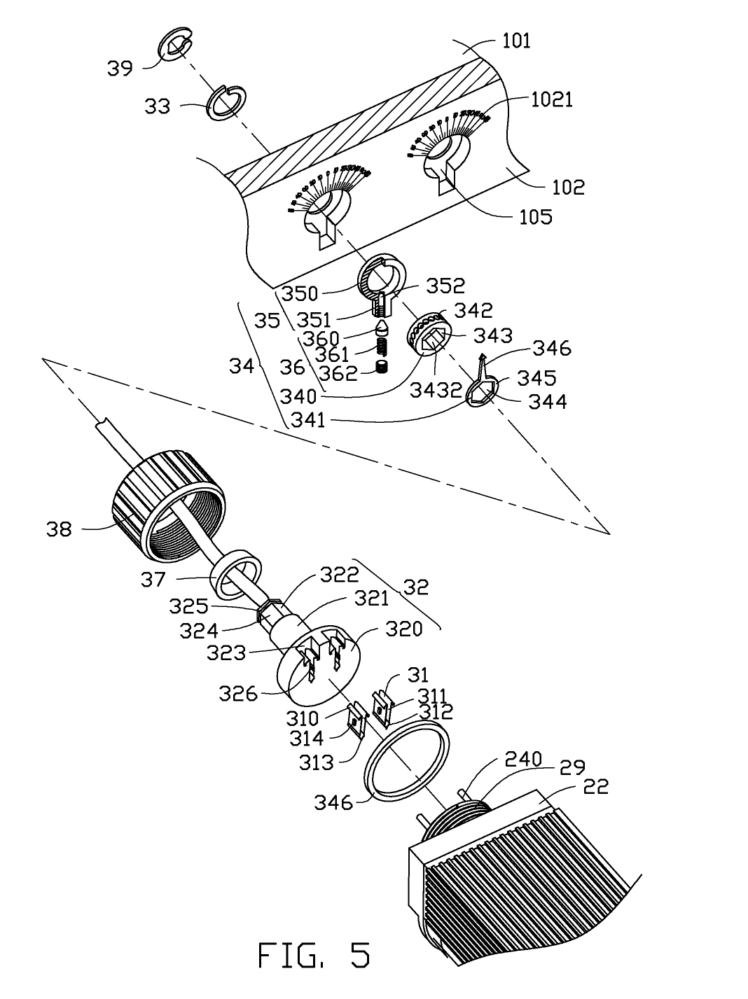

Two connection units 22 are located at two opposite terminals of the lamp module 21, and hermetically seal the lamp module 21 therebetween. Two connectors 30 respectively engage with the two connection units 22 to adjust illumination angle of the illumination unit 20 via two adjusters 34 (shown in FIG. 5).

Each connection unit 22 includes a cover 23, a lamp plug 24 located at a side of the cover 23, and a seal piece 25 between the heat dissipating case 204 of the lamp module 21 and the cover 23. A plurality of screws 26 extends through the cover 23, the seal piece 25 and engages in a corresponding corner of the heat dissipating case 204. Thus the cover 23, the heat dissipating case 204 and the seal piece 25 are hermetically connected together to make the lamp module 21 waterproof.

Each cover 23 includes a location piece 27, a step portion 28 and a threaded neck 29. The location piece 27 extends from a top end of the cover 23. The location piece 27 is inserted into the lamp module 21 and contacts the inner surface of the light guide housing 202. The step portion 28 is located on an outer side of the cover 23 opposite to the lamp module 21. The step portions 28 can fittingly engage in the cutouts 103 of the mounting plates 12 at opposite edges of the opening 11 of the lamp base 10 as shown in FIG. 2, to position each lamp module 21 at an appropriate orientation. The threaded neck 29 is substantially a cylinder extending outwardly from the cover 23, and is parallel to the lamp module 21. Each threaded neck 29 includes threads on an outer circumferential periphery thereof to threadedly engage with a corresponding connector 30. Three locking grooves 243 are located on an inner circumferential periphery of the threaded neck 29. The lamp plug 24 is received in the threaded neck 29 and electrically insulates from the threaded neck 29. The lamp plug 24 is made of electrically insulating material such as plastic, while the cover 23 is made of metal or plastic.

The lamp plug 24 includes two contact pins 240 on the outer surface opposite to the lamp module 21, and electrically connecting the printed circuit board 207 via the power cord 241. In this embodiment, the contact pins 240 located at opposite ends of the lamp module 21 have opposite polarities. The lamp plug 24 includes three tenon bars 242 for fittingly engaging in the three locking grooves 243 when the lamp plug 24 is inserted into the threaded neck 29. The locking grooves 243 and the tenon bars 242 help to readily appropriately position the lamp plug 24 in a corresponding cover 23, so a virtual plane extending through centers of the two contact pins 240 is parallel to the heat dissipating base 203. Accordingly, the two contact pins 240 can smoothly insert into the connector 30 of FIG. 1, and keep the illumination unit 20 at a predetermined orientation. The lamp plug 24 defines a through hole 244 therein. A screw (not labeled) extends through the through hole 244 and engages in a threaded tube 245 of the threaded neck 29 to fix the lamp plug 24 to the cover 23. Thus, the heat dissipating case 204 is sealed to make the illumination units 20 waterproof.

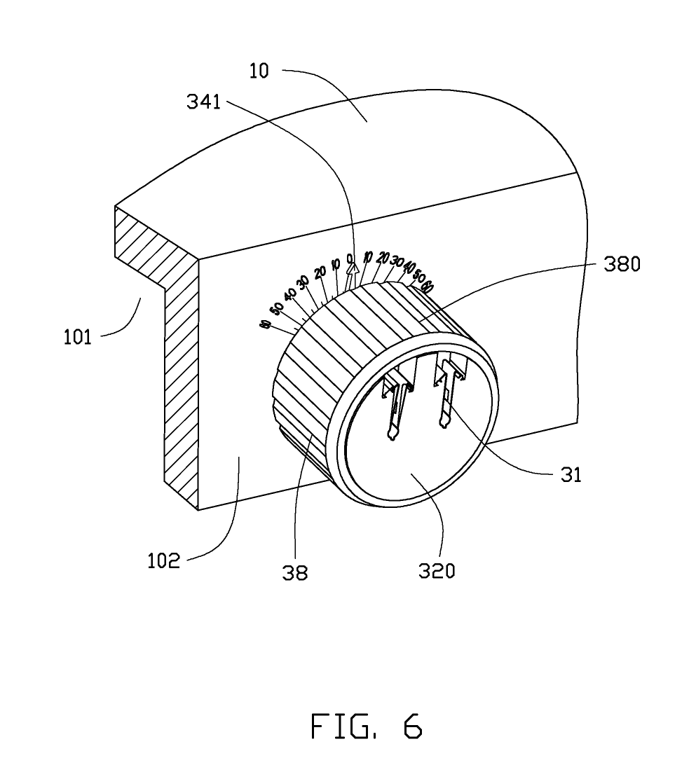

Referring also to FIGS. 5-6, the connector 30 includes a socket 32 and the adjuster 34. The socket 32 includes a socket base 320, a neck portion 321, and an orientation portion 322.

The socket base 320 is cylindrical and defined two slots 323 corresponding to the contact pins 240. The slots 323 extend from an outer periphery of the socket base 320 to an inside of the socket base 320 along two parallel lines. The slots 323 are spaced from and parallel to each other. Two socket clips 31 are respectively received in the two slots 323.

Each socket clip 31 is substantially a V-shaped spring, and has an outer surface corresponding to each slot 323. From top to bottom, each socket clip 31 defines two inverted, V-shaped hooked fasteners 310, two sidewalls 311 respectively extending from the fasteners 310, two expansion portions 312 respectively extending from the sidewalls 311 and a weld portion 313 interconnecting bottoms of the two expansion portions 313. The expansion portions 312 of the corresponding socket clip 31 hold a corresponding contact pin 240 therebetween. The weld portion 313 electrically connects the power cord 10a extending into the slot 323.

The socket base 320 includes a cone surface (not shown) connecting the neck portion 321. The socket base 320, the neck portion 321, and the orientation portion 322 are coaxial. The neck portion 321 and the orientation portion 322 are respectively round and polygonal cylinders and the neck portion 321 is located between the socket base 320 and the orientation portion 322. A diameter of the neck portion 321 is less than that of the socket base 320. A plurality of planar surfaces 324 are formed on an outer periphery of the orientation portion 322. A width of the orientation portion 322 is less than that the diameter of the neck portion 321. An end of the orientation portion 322 defines a plurality of grooves 325 around a periphery of the end of the orientation portion 322. The end is away from the socket base 320. The orientation portion 322 is fittingly engaged in a mounting hole 105 of the connecting plate 102 of the wire chute 101 to keep the socket 32 arranged at a predetermined orientation.

When the socket 32 is assembled, the power cord 10a extends from a center of the orientation portion 322 to the socket base 320. The power cord 10a is below the slots 323 and welded on the weld portions 313 of the sockets clips 31 to electrically connect the socket clips 31 when the sockets clips 31 are inserted in the slots 323. Then the socket clips 31 are received in the corresponding slots 323. The socket clip 31 fittingly engages in the slot 323 and the fasteners 310 of the socket clip 31 are fittingly engaging in two hooked cavities (not labeled) defined in opposite sides of an upper portion of the slot 323. The contact pins 240 each are inserted into a corresponding socket clip 31 via the guidance of the fasteners 310 thereof to be positioned between the expansion portions 312 of the corresponding socket clip 31. Each expansion portion 312 has an inner surface fittingly engaging with the outer surface of the corresponding contact pin 240, so to increase the contact area between the socket clip 31 and the contact pin 240. For each socket clip 31, the minimum distance between the two sidewalls 311 is less than the diameter of the contact pin 240. Accordingly, the socket clips 31 can clip the contact pins 240, and keep the positions of the contact pins 240. Each socket clip 31 further forms two protrusions 314 on outer surfaces of the two sidewalls 311. The protrusions 314 are elastically received in two holes 326 defined in the inner surface of the slot 323, so movement of the lamp plug 24 will not cause the socket clips 31 to separate from the socket base 320.

The adjuster 34 includes a stator 35, a rotator 340, a position member 36 and a pointer 341. In an alternative embodiment, the pointer 341 may be not necessary. The stator 35 includes an annular main body 350 and an extending portion 351 extending from the main body 350. The main body 350 and the extending portion 351 are integrative. A cross section of the extending portion 351 is rectangular. A guiding hole 352 is defined in a central portion of the extending portion 351 along an extending direction of the extending portion 351 and extends through the main body 350. A top portion of the guiding hole 352 reaches to an inner surface of the main body 350 and a cross section thereof is cone-shaped. A cross section of a bottom portion of the guiding hole 352 is round. A plurality of threads is defined in the bottom portion of the guiding hole 352.

The rotator 340 is cylindrical and fitly engages in the main body 350 of the stator 35. A plurality of recesses 342 are defined in an outer periphery of the rotator 340 along a circumferential direction of the rotator 340. A polygonal through hole 343 is defined in a central portion of the rotator 340. A plurality of rectangular engaging surfaces 3432 is defined on an inner surface of the rotator 340 around the through hole 343. In this embodiment, the engaging surfaces 3432 have a quantity which is equal to that of the planar surfaces 324 of the orientation portion 322 of the socket 32. The engaging surfaces 3432 fittingly abut the planar surfaces 324 when the orientation portion 322 engages in the rotator 340.

The position member 36 includes a pin 360, an elastic element 361 and a stopper 362. A top portion of the pin 360 is cone-shaped and a bottom portion of the pin 360 is cylindrical. The top portion of the pin 360 fitly engages in the top portion of the guiding hole 352. The pin 360 is slidable along the top portion of the guiding hole 352. The bottom portion of the pin 360 is received in the bottom portion of the guiding hole 352. A diameter of the bottom portion of the pin 360 is less than that of an aperture of the bottom portion of the guiding hole 352. In this embodiment, the elastic element 361 is a helical spring. The stopper 362 is a nut. The elastic element 361 is sandwiched between the pin 360 and the stopper 362. The stopper 363 engages with threads of the guiding hole 352.

The pointer 341 includes a mounting portion 345 and an indicator 346 extending from the mounting portion 345. A polygonal through hole 344 is defined in a central portion of the mounting portion 345. A plurality of planar surfaces are defined on an inner surface of mounting portion 345 around the through hole 344. A number of the planer surfaces are equal to that of the engaging surfaces 3432 of the rotator 340. The mounting portion 345 is corresponding to the rotator 340 and surrounds the orientation portion 322.

The stator 35, the rotator 340 and the position member 36 are assembled together firstly when the adjuster 34 is assembled. In assembly, the rotator 340 is inserted in the main body 350. The pin 360 is inserted in the guiding hole 352 from the extending portion 351 of the stator 35. The elastic element 361 is received in the guiding hole 352, and then the stopper 362 is received in the guiding hole 352 and screws with the threads of the guiding hole 352. The elastic element 361 is compressed to push the pin 360 toward the rotator 340 until the top portion of the pin 360 engages in a corresponding recess 342 of the rotator 340.

A dial 1021 is formed on an inner surface of the connecting plate 102 at a location above of the mounting hole 105. The dial 1021 shows a rotation angle of the adjuster 34 which the adjuster 34 is rotated from one orientation to another orientation. The indicator 346 of the pointer 341 is used to point out the scale of the dial 1021. When the stator 35, the position member 36, and the rotator 340 are assembled together, the stator 35 fitly engages in the mounting hole 105.

The connector 30 further includes a holding base 38 and a seal ring 37. The holding base 38 is a hollow cap. A plurality of strips 380 is formed on an outer periphery of the holding base 38 for the convenience of holding and rotating the holding base 38. A plurality of threads is formed on an inner periphery of the holding base 38 to engage with the threaded neck 29 of the illumination unit 20. When the connector 30 is assembled, the power cord 10a connecting to the socket 32 extends through the seal ring 37 and the holding base 38. The seal ring 37 and the holding base 38 are moved toward the neck portion 321 to make the seal ring 37 enclose the cone surface of the neck portion 321 and abut the socket base 320. The orientation portion 322 extends through the through hole 344 of the mounting portion 345 of the pointer 341 and the through hole 343 of the rotator 340 in sequence when the rotator 340 is assembled with the stator 35 and the stator 35 is received in the mounting hole 105 of the connecting plate 102. In this state, the orientation portion 322 extends through the mounting hole 105. After a spring washer 33 engaging with the orientation portion 322, a C-shaped retainer 39 inside the wire chute 101 engages in the groove 325 of the orientation portion 322 to fix the connector 30 on the wire chute 101. In this sate, an outer end the holding base 38 tightly abuts against the seal ring 37. Thus, the wire chute 101 is sealed to make the connector 30 waterproof. The connector 30 can also be disassembled through an operation in reverse order of the above mentioned operation.

The illumination unit 20 can be easily assembled to and disassembled from the connectors 30, without using a tool. In assembly, the holding bases 38 are pushed toward the connecting plates 102 of the wire chutes 101 to expose the socket clips 31. A seal ring 346 is brought to surround threaded necks 29 of the connection units 22 and contact the covers 23. The contact pins 240 of the lamp plugs 24 are pushed into the expansion portions 312 from top of the socket chips 31. The step portions 28 fittingly engage in the cutout 103 of the mounting plates 12. The holding bases 38 are pushed toward the connection units 22 and threadedly engage with the threaded necks 29 by rotating the holding bases 38 on the threaded necks 29. Thus, the illumination unit 20 is sealed to the connectors 30 to make the assembly waterproof and safety.

When the LED lamp is assembled completely, the heat dissipating base 203 of a corresponding illumination unit 20 is parallel to the mounting plate 12 (as shown in FIG. 1). In other words, the heat dissipation base 203 is horizontally oriented. In this state, the indicator 346 of the pointer 341 points 0 degree of the dial 1021 (as shown in FIG. 6). If the illumination angle of the illumination unit 20 is needed to be adjusted, the holding bases 38 are rotated. The illumination unit 20 rotates with the holding bases 38 to change an illumination direction of the LED elements 2062. In this process, the illumination angle of the illumination unit 20 is changed by rotating the arc-shaped step portion 28 onto the cutouts 103 of the mounting plates 12 at an appropriate orientation. The socket 32, the rotator 340 and the pointer 341 rotate with the illumination unit 20, simultaneously. When the indicator 346 of the pointer 341 points to a predetermined degree, the holding base 38 is released, the heat dissipating base 203 is angled with the mounting plate 12, and the pin 360 of the position member 36 is inserted in a corresponding recess 342 of the rotator 340 to position the adjuster 34 at the predetermined orientation. The illumination unit 20 assures a predetermined illumination angle.

Accordingly, the illumination units 20 can be easily adjusted to a predetermined orientation by rotating the connectors 30 to assure various angles of illumination. Since the LED lamp is formed by the modularized illumination modules and illumination units 20, the LED lamp can be easily modified for various applications. In addition, the connection units 22 enable easier manual repair of the suspended LED lamp. Repairmen can quickly replace the illumination unit 20 without tools.

Accordingly, the present disclosure includes the following advantages:

First, the LED lamp of the present disclosure can be easily modified because of the use of the modularized illumination units. The illumination units each integrate electrics, optics and heat dissipation into a single unit, and can operate individually. The manufacture of the LED lamps is simplified, and the cost can be effectively reduced.

Secondly, the LED lamp of the present disclosure provides great thermal efficiency. The hollow heat dissipating assembly has a large heat absorbing area and a large dissipating area, and the gaps between the illumination units enhance natural convection. As such, illuminating efficiency and light weight of the LED lamp are ensured, and lifetime of the LED lamp is increased.

Thirdly, the LED lamp of the present disclosure assures various angles of illumination. The illumination surfaces of the illumination units are adjusted to the predetermined location by operating the adjuster.

Fourthly, the LED lamp of the present disclosure reduces the cost of disassembly and repair. The connectors enable easier manual repair of the suspended illumination units. Repairmen can quickly replace the illumination unit without tools. Accordingly, the LED lamp provides better maintenance quality, assembly convenience, and disassembly convenience.

Fifthly, the present disclosure provides an outdoor LED lamp with excellent weatherability. The LED lamp is protected from rain, humidity, dust, sunshine. The snow load, the drag coefficient, the amount of dust and sand deposition are reduced. Thus, safety and reliability are enhanced.

It is to be understood, however, that even though numerous characteristics and advantages of the embodiment(s) have been set forth in the foregoing description, together with details of the structures and functions of the embodiment(s), the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A connector adapted for electrically connecting a lamp plug of an illumination unit and fixing the illumination unit to a connecting plate, the lamp plug comprising contact pins, the connector comprising:
a socket, the contact pins of the illumination unit inserted in the socket to make the illumination unit and the socket be assembled together; and
an adjuster, the adjuster comprising a stator embedded in the connecting plate, a rotator engaging with the stator and rotatable relative to the stator, the rotator surrounding an end of the socket and rotating with the socket to change an illumination angle of the illumination unit.

2. The connector of claim 1, wherein the adjuster further comprises a position member, a guiding hole is defined in the stator, the position member is received in the guiding hole and abuts the rotator to make the rotator fixed relative to the stator.

3. The connector of claim 2, wherein the stator is hollow and the rotator is embedded in the stator, a plurality of recesses is defined in an outer periphery of the rotator along a circumferential direction of the rotator, and the position member inserts a corresponding recess and abuts the rotator.

4. The connector of claim 2, wherein the position member comprises a pin, an elastic element, and a stopper, the pin, the elastic element, and the stopper are received in the guiding hole, and the elastic element is between the stopper and the pin, the stopper engages with an inner surface of the guiding hole, the elastic element pushes the pin abutting the rotator when the elastic element is compressed.

5. The connector of claim 4, wherein the elastic element is a helical spring and the stopper is a screw.

6. The connector of claim 1, wherein the adjuster further comprises a pointer, the pointer comprising a mounting portion surrounding the socket and an indicator extending from the mounting portion, and the pointer is located at a side of the rotator.

7. An LED lamp comprising:
a lamp base, the lamp base comprising a main body and an extending portion extending from the main body, at least one opening defined in the main body;
a plurality of illumination units with LED elements received in the opening of the main body of the lamp base; and
two connectors respectively engaging with opposite ends of the illumination unit and the main body to fix the illumination unit on the lamp base, each of the connector comprising:
a socket electrically connecting the illumination unit; and
an adjuster, the adjuster comprising a stator embedded in the main body of the lamp base, and a rotator engaging with the stator and rotatable relative to the stator, the rotator surrounding an end of the socket and rotating with the socket to change an illumination angle of the illumination unit.

8. The LED lamp of claim 7, wherein the adjuster further comprising a position member, a guiding hole is defined in the stator, the position member is received in the guiding hole and abuts the rotator to make the rotator fixed relative to the stator.

9. The LED lamp of claim 8, wherein the stator is hollow and the rotator is embedded in the stator, a plurality of recesses is defined in an outer periphery of the rotator along a circumferential direction of the rotator, and the position member inserts a corresponding recess and abuts the rotator.

10. The LED lamp of claim 8, wherein the position member comprises a pin, an elastic element, and a stopper, the pin, the elastic element, and the stopper are received in the guiding hole, and the elastic element is between the stopper and the pin, the stopper engages with an inner surface of the guiding hole, the elastic element pushes the pin abutting the rotator when the elastic element is compressed.

11. The LED lamp of claim 7, wherein a dial is formed on the main body at an edge of the opening, the adjuster further comprises a pointer surrounding the socket to point out scale of the dial.

12. The LED lamp of claim 7, wherein the lamp base is defined two wire chutes located opposite sides of the opening to store power cords therein, and the connectors are fixed on the wire chutes and electrically connected the power cords.

13. The LED lamp of claim 12, wherein two mounting plates respectively covering the wire chutes and the connecters.

14. The LED lamp of claim 13, wherein a drainage pipeline is defined between the mounting plate and the wire chute to drain water from the LED lamp.

15. The LED lamp of claim 13, wherein a bottom end of the mounting plate is defined a cutout to receive an end of the illumination unit therein.

16. The LED lamp of claim 7, wherein the socket comprises a socket base and an orientation portion extending from the socket base, the socket base electrically connects the illumination unit, and the rotator surrounds the orientation portion.

17. The LED lamp of claim 16, wherein two slots are defined in the socket base, two socket clips are received in the slots, two contact pins formed on an end of the illumination unit, the two contact pins are inserted in the socket clips.

18. The LED lamp of claim 16, wherein a thread neck extending from the illumination unit, a hollow holding base screws with the thread neck of the illumination unit and receives the socket therein.

19. The LED lamp of claim 7, wherein the illumination unit comprises a lamp module and two connection units connected opposite ends of the lamp module.

20. The LED lamp of claim 19, wherein the lamp module comprises a heat dissipating assembly and a light source base mounted on the heat dissipating assembly, the LED elements are mounted on the light source base.
